(19) United States
(12) Patent Application Publication
(10) Pub. No.: US 2013/0031074 A1
(43) Pub. Date: Jan. 31, 2013

(54) APPARATUS AND METHOD FOR PROVIDING INTELLIGENT INFORMATION SEARCHING AND CONTENT MANAGEMENT

(71) Applicants: Harry Vartanian, Philadelphia, PA (US); Jaron Jurikson-Rhodes, Philadelphia, PA (US)

(72) Inventors: Harry Vartanian, Philadelphia, PA (US); Jaron Jurikson-Rhodes, Philadelphia, PA (US)

(73) Assignee: HJ LABORATORIES, LLC, Philadelphia, PA (US)

(21) Appl. No.: 13/189,950

(22) Filed: Jul. 25, 2011

(51) Int. Cl. G06F 17/30

(52) U.S. Cl. 707/706; 707/E17.108

(57) ABSTRACT

An apparatus and method for providing intelligent searching of information and content management that is sensitivity aware, privacy aware, or privacy protected is disclosed. Also, an apparatus and method for providing intelligent searching based on intelligent context is provided.

### FIELD OF INVENTION

This application is related to an apparatus and method for providing intelligent information and content management by accounting for privacy and/or user context.

### BACKGROUND

Search engines are an essential part of the information age and the Internet. However, a lack of privacy is prevalent in the information age in part because of search engines. Whether by choice by placing information on the web, such as social networking sites, or an accidental leak of information by a third party, private or confidential information can easily be found via search engines on the Internet or public databases. This information can sometimes be embarrassing or damaging to a person's, company's, government's, etc. reputation when discovered, such as during background checks.

Context, such as a user's location, may be used to provide better search results from a search engine and/or smarter computing. However, current user devices lack the intelligence to use context to infer user states, emotions, moods, scenarios, situations, events, or the like. The lack of intelligence results in less than ideal search results.

It is desirable to provide searching of information to provide better privacy and search results.

### SUMMARY

An apparatus and method for providing intelligent searching of information and content management that is sensitivity aware, privacy aware, or privacy protected is disclosed. Also, an apparatus and method for providing intelligent searching based on intelligent context is provided.

### BRIEF DESCRIPTION OF THE DRAWINGS

A more detailed understanding may be had from the following description, given by way of example in conjunction with the accompanying drawings wherein:

FIG. 1 is a diagram of an object device;

FIG. 2 is an apparatus for providing intelligent searching;

FIG. 3a is a process for providing intelligent searching that is sensitivity aware, privacy aware, or privacy protected;

FIG. 3b is an example of search results provided by intelligent searching; and

FIG. 4 is a process for providing intelligent searching based on intelligent context.

### DETAILED DESCRIPTION

The present embodiments will be described with reference to the drawing figures wherein like numerals represent like elements throughout. For the methods and processes described below the steps recited may be performed out of sequence in any order and sub-steps not explicitly described or shown may be performed. In addition, “coupled” or “operatively coupled” may mean that objects are linked between zero or more intermediate objects. Also, any combination of the disclosed features/elements may be used in one or more embodiments. When using referring to “A or B”, it may include A, B, or A and B, which may be extended similarly to longer lists.

In the examples forthcoming, a user or computer may determine or find that certain information is sensitive or negative online or in a database. If the information cannot be removed, examples are given where the sensitive or negative information may be buried, hidden, concealed, made irrelevant, etc. by increasing the order, rank, relevance, or placement of other information in search results. In addition, the order, rank, relevance, or placement of sensitive or negative information may be substantially decreased such that it cannot easily be discovered.

In the examples forthcoming, intelligent context may be used to determine the state of a device or user. The state may then be provided to a search engine, an application on the device, an application online, any online service, or the like to provide intelligent computing.

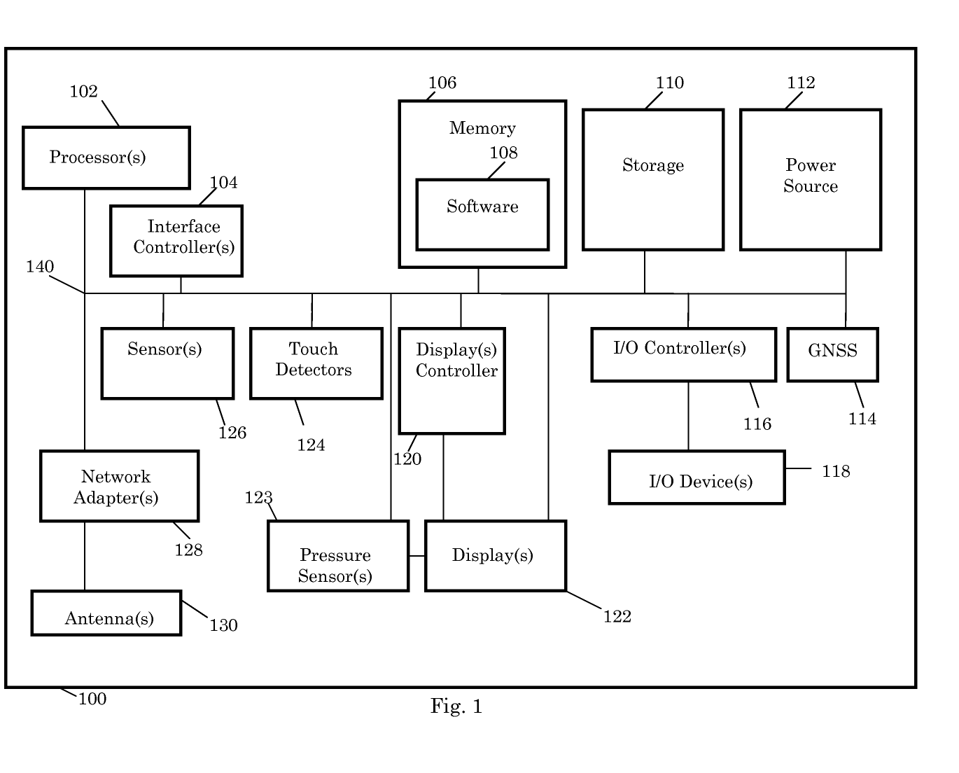

FIG. 1 is a diagram of an object device 100 that may be configured as a server, computer, client device, part of a cloud based machine, an application service provider machine, wireless subscriber unit, user equipment (UE), mobile station, smartphone, pager, mobile computer, cellular telephone, telephone, personal digital assistant (PDA), computing device, surface computer, tablet computer, monitor, medical device, general display, versatile device, appliance, automobile computer system, vehicle computer system, part of a windshield computer system, television device, home appliance, home computer system, laptop, netbook, tablet computer, personal computer (PC), an Internet pad, digital music player, peripheral, add-on, an attachment, virtual reality device, media player, video game device, head-mounted display (HMD), helmet mounted display (HMD), glasses, goggles, a component of another device, or any electronic device for mobile or fixed applications.

Object device 100 comprises computer bus 140 that couples one or more processors 102, one or more interface controllers 104, memory 106 having software 108, storage device 110, power source 112, and/or one or more displays controller 120. Object device 100 includes one or more display devices 122.

One or more display devices 122 can be configured as a plasma, liquid crystal display (LCD), light emitting diode (LED), field emission display (FED), surface-conduction electron-emitter display (SED), organic light emitting diode (OLED), or flexible OLED display device. The one or more display devices 122 may be configured, manufactured, produced, or assembled based on the descriptions provided in U.S. Patent Publication Nos. 2007-247422, 2007-139391, 2007-085838, or 2006-096392 or U.S. Pat. No. 7,050,835 or WO Publication No. 2007-012899 all herein incorporated by reference as if fully set forth. In the case of a flexible or bendable display device, the one or more electronic display devices 122 may be configured and assembled using organic light emitting diodes (OLED), liquid crystal displays using flexible substrate technology, flexible transistors, field emission displays (FED) using flexible substrate technology, or the like.

One or more display devices 122 can be configured as a touch, multi-touch, multiple touch, or swipe screen display using resistive, capacitive, surface-acoustic wave (SAW) capacitive, infrared, strain gauge, optical imaging, dispersive signal technology, acoustic pulse recognition, frustrated total internal reflection, magneto-strictive technology, or the like. One or more display devices 122 can also be configured as a three dimensional (3D), electronic paper (e-paper), or electronic ink (e-ink) display device.

Coupled to one or more display devices 122 may be pressure sensors 123. Coupled to computer bus 140 are one or more input/output (IO) controller 116, IO devices 118, global navigation satellite system (GNSS) device 114, one or more network adapters 128, and one or more antennas 130. Examples of IO devices include a speaker, microphone, keyboard, keypad, touchpad, display, touchscreen, wireless gesture device, a digital camera, a digital video recorder, a vibration device, universal serial bus (USB) connection, a USB device, or the like. An example of GNSS is the Global Positioning System (GPS).

Object device 100 may be configured such that a reserved battery source in power source 112 is used for GNSS device 114. In addition, object device 100 may automatically shut down when it is very low on power or near dead while maintaining enough power in power source 112 such that GNSS device 114 still operates for at least 12 hours. This ensures that in a case of emergency or need, object device 100 still may report its position to emergency personnel, a social networking site, and/or any other location based service application (e.g. Latitude or Loopt).

Object device 100 may have one or more motion, movement, rotation, zoom, proximity, light, infrared, optical, chemical, biological, environmental, moisture, acoustic, heat, temperature, humidity, barometric pressure, radio frequency identification (RFID), biometric, biometric feedback, pulse, brainwaves, face recognition, text recognition, image recognition, graphics recognition, photo recognition, video recognition, speech recognition, audio recognition, music recognition, and/or voice recognition sensors 126. One or more sensors 126 may be configured as a digital camera, infrared camera, accelerometer, multi-axis accelerometer, an electronic compass (e-compass), gyroscope, multi-axis gyroscope, a 3D gyroscope, or the like. One or more sensors 126 may be made part of or integrated in a smart shell, smart case, or smart form factor of object device 100. For instance, electrodes may be placed on smart shell, smart case, or smart form factor of object device 100 to detect states, such as a pulse, body fat content, and/or skin conductivity of a user by running current or applying a voltage between a user's fingers or hands.

Object device comprises touch detectors 124 for detecting any touch inputs, including multi-touch inputs and swipe inputs, for one or more display devices 122. One or more interface controllers 104 may communicate with touch detectors 124 and IO controller 116 for determining user inputs to object device 100. Coupled to one or more display devices 122 may be pressure sensors 123 for detecting presses on one or more display devices 122.

Still referring to object device 100, storage device 110 may be any disk based or solid state memory device for storing data. Power source 112 may be a plug-in, battery, fuel cells, solar panels for receiving and storing solar energy, or a device for receiving and storing wireless power as described in U.S. Pat. No. 7,027,311 herein incorporated by reference as if fully set forth. Power source 112 may be one or more batteries such as nickel-cadmium (NiCd), nickel-zinc (NiZn), nickel metal hydride (NiMH), lithium-ion (Li-ion), or the like.

One or more network adapters 128 may be configured as an Ethernet, 802.x, fiber optic, Frequency Division Multiple Access (FDMA), single carrier FDMA (SC-FDMA), Time Division Multiple Access (TDMA), Code Division Multiple Access (CDMA), Orthogonal Frequency-Division Multiplexing (OFDM), Orthogonal Frequency-Division Multiple Access (OFDMA), Global System for Mobile (GSM) communications, Interim Standard 95 (IS-95), IS-856, Enhanced Data rates for GSM Evolution (EDGE), General Packet Radio Service (GPRS), Universal Mobile Telecommunications System (UMTS), cdma2000, wideband CDMA (W-CDMA), High-Speed Downlink Packet Access (HSDPA), High-Speed Uplink Packet Access (HSUPA), High-Speed Packet Access (HSPA), Evolved HSPA (HSPA+), Long Term Evolution (LTE), LTE Advanced (LTE-A), 802.11x, Wi-Fi, Zigbee, Ultra-WideBand (UWB), 802.16x, 802.15, Wi-Max, mobile Wi-Max, Bluetooth, radio frequency identification (RFID), Infrared Data Association (IrDA), near-field communications (NFC), or any other wireless or wired transceiver for modulating and demodulating signals via one or more antennas 130. One or more network adapters 128 may also be configured for automobile to automobile, car to car, vehicle to vehicle (V2V), or wireless access for vehicular environments (WAVE) communication. One or more network adapters 128 may also be configured for human body communications where the human body is used as a medium to communicate data between at least two computers or devices coupled to the human body.

For certain configurations, such as a server, selective components are provided from object device 100 to be configured as a server. Moreover, object device 100 may specifically be configured to operate for any of the examples forthcoming for apparatuses and processes. Any of devices, controllers, displays, components, etc. in object device 100 may be combined, made integral, removed, or separated as desired.

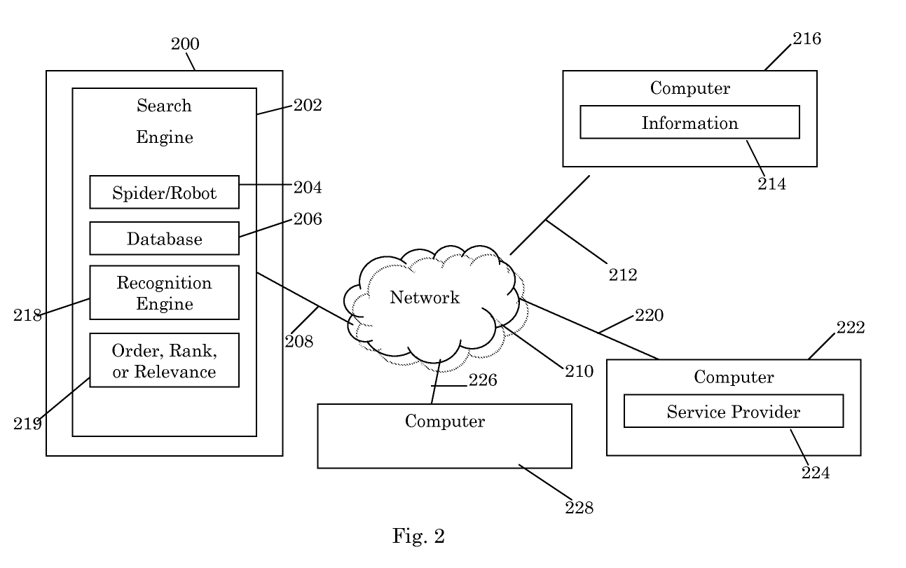

FIG. 2 is an apparatus 200 for providing intelligent searching. Apparatus 200 may have some parts or components of object device 100 including a one or more processors 102 and memory 106. Apparatus 200 may be configured as a server, computer, client device, part of a cloud based machine, an application service provider (ASP) machine, or the like. Apparatus 200 may include search engine 202 having spider or robot component 204, database 206, recognition engine 218, and order, rank, or relevance component 219. Search engine 202 accesses information 214 on computer 216 via network 210 using wired or wireless communication links 208 and 212. Parts of search engine 202 may operate in memory 106 and reside in storage device 110. In addition to apparatus 200, other parts of search engine 202 may exist and operate on other computers (not shown) to provide intelligent searching.

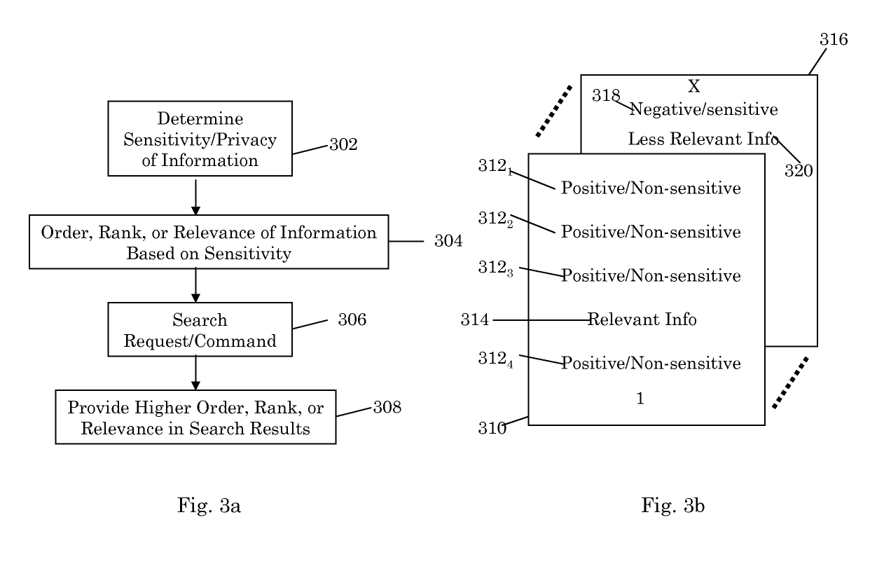

FIG. 3a is a process for providing intelligent searching that is sensitivity aware, privacy aware, or privacy protected. Search engine 202 or parts of a search engine on one or more servers, a cloud service, the World Wide Web (WWW), or locally on an intranet on apparatus 200 determines the sensitivity or privacy of information 214 (302). The determining of sensitivity or privacy of information 214 may be performed on the fly during crawling or spidering by spider or robot component 204 or any other software component. In addition, the determining of sensitivity or privacy of information 214 may be performed after spider or robot component 204 retrieves information 214 and stores it in database 206. Moreover, the determining of sensitivity or privacy may be performed on parts or segments of information 214.

Information 214 may be part of or wholly a webpage, user comments, user group information, message board information, text messages, describe a topic, specific subject matter, user information, personal information, private information, user data, group information, company information, metatags, text, images, graphics, audio, video, music, multimedia information, tweets, social networking information, news, magazine information, a blog, emails, credit card information, telephone numbers, email addresses, mailing addresses, social security numbers, unsecured information from private databases, or the like.

Moreover, search engine 202 may have recognition engine 218. Recognition engine 218 may use a neural network or artificial intelligence to determine the sensitivity of information 214. Part of recognition engine 218 may include one or a combination of text recognition, image recognition, graphics recognition, speech recognition, voice recognition, audio recognition, music recognition, video recognition, facial recognition, or the like. Recognition may be provided based on correlation or comparing of decomposed, dismantled, or parsed parts of information 214 to known attributes, markers, words, dictionary, features, or the like. Examples of recognition engines may include U.S. Patent Publication Nos. 2010-0260424 and 2009-0116702 and/or U.S. Pat. No. 7,787,697 all herein incorporated by reference as if fully set forth.

Part of the determining or detecting of information 214 may include determining or identifying the mood, emotions, or type of information found by search engine 202 and/or spider or robot component 204. For instance, text, image, graphics, audio, video, music, etc. may be determined or tagged as sensitive because of having attributes or markers of anger, racism, illegal, dangerous, sensuality, embarrassment, inappropriate behavior, adult content, violence, shame, sadness, or the like. Search engine 202 may also determine the sensitivity based on information 214 being associated with a special time or event such as a wedding, party, college, childhood, adolescence, private family event, or the like.

Moreover, other identifiable mood or emotion attributes or markers include amusement, delight, elation, excitement, happiness, joy, pleasure, courage, hope, pride, satisfaction, trust, calm, relaxed, relieved, surprised, stressed, shocked, tension, despair, disappointment, hurt, frustration, guilt, shame, envy, anxiety, embarrassed, fear, rage, worry, annoyance, disgust, irritation, or the like and any combinations thereof.

In addition to information 214, search engine 202 and/or spider or robot component 204 may identify all other information related to information 214 for the examples given. This in effect may help to determine the sensitivity of information related to information 214 to provide more comprehensive overall privacy protection.

Once the various attributes or markers of information 214 are identified, they may be weighted and summed using a predetermined or custom formula to give a sensitivity score by search engine 202. For instance, positive attributes or markers are given high positive values while negative attributes or markers are given high negative values. Moreover, a scale may be used to provide a range of values and intensities of attributes or markers. Once the values are determined, a sensitivity score is calculated by search engine 202.

In addition to search engine 202, a user or service provider representing the user may flag certain information or content discovered online as sensitive and electronically report it to search engine 202. In return, search engine 202 may make note of the sensitivity of the information and may consider it when returning search results.

Once the sensitivity of information 214 is determined or detected it may be placed in order, rank, or relevance with other related information and indexed or listed in database 206 (304) by order, rank, or relevance component 219. Alternatively, the order, rank, relevance of information 214 may be performed on the fly in response to a search request by search engine 202. A search request may be a whole input, whole inquiry, or part of a request in real-time as a user types information 214.

Information 214 may be weighted based on different scales of sensitivity. Moreover, a hash table may be used to provide or assign a numerical value to parts of information 214 depending on sensitivity or relevancy, as desired. The order, rank, or relevance may also be based on how much information 214 is cited or linked by others on the Internet in combination with determined sensitivity.

Order, rank, or relevance component 219 may place higher value on information 214 having less sensitive or positive attributes and/or lower value if information 214 has highly sensitive or negative data. Moreover, determining the sensitivity, order, rank, or relevance may be done iteratively due to the possibility of information 214 changing over time.

Once search engine 202 ranks or orders information 214 it may choose to remove or delete the information or parts of the information if it is too sensitive or negative from database 206. However, this may not be an option due to freedom of speech laws, freedom of press laws, or the search engine user policy.

As another option, search engine 202 may conceal or hide information 214 by assigning a random, secret, or predetermined lower order, rank, or relevance to highly sensitive or negative data such that it results in information 214 appearing many pages down from the first page of search results. The reduction or decrease in order, rank, or relevance ensures that information 214 that is highly sensitive or negative cannot easily be found and kept private since a typical user may only look at up to the first few pages of search results.

In addition, the owner of information 214 may be given the option by search engine 202 or a third party site of what types or classes of information to reveal in a search. The owner of information 214 may be given the option by search engine 202 or a third party site to input metrics to determine the sensitivity of information 214. For instance, on a social networking site the owner of information 214 may place a positive metric to multimedia or text related to a vacation but place a negative metric to multimedia or text related to a romantic relationship. These metrics may then be considered by search engine 202 when found during a crawl or spidering by spider or robot component 204.

Hiding and concealing of information 214 may not be possible sometimes since search engine 202 may want to provide all relevant results, positive or negative, based on a user's request. Removal or deletion of information 214 from database 206 may be time consuming for a person, organization, or entity since many dynamic search engines exist on the Internet and may not even be possible due to search engine's 202 policy or freedom of speech laws.

Referring again to FIG. 2, service provider 224 on computer 222 may be provided to assist, alter, or direct the crawling or spidering of spider or robot component 204 over wired or wireless link 220 such that information 214 is not found, concealed, buried, or removed from one or more search engines. In addition, service provider 224 may be configured to assist or alter the crawling or spidering operation of spider or robot 204 by causing search engine 202 to reduce or decrease the order, rank, or relevance of information 214 when indexed if it is determined to have negative sensitivity. The reduction or decrease of the order, rank, or relevance of information 214 may be done such that it results in a random, secret, or predetermined lower order, rank, or relevance. Service provider 224 may be configured to assist or alter the crawling or spidering of spider or robot component 204 by causing search engine 202 to increase the order, rank, or relevance of information 214 if it is determined to have positive sensitivity. The determining of sensitivity by service provider 224 may be performed as previously mentioned above for search engine 202.

Altering or assisting by service provider 224 may be performed by dynamically developing decoy pages or sites on the Internet that result in increasing the order, rank, or relevance of positive information while decreasing the order, rank, or relevance of negative information in an index or list stored in database 206. This may be done by causing the increase of linking to pages having positive information and decrease the linking to pages having negative information.

As another option, altering or assisting may be performed by adaptively using the inverse order, rank, relevance, or indexing algorithm of search engine 202 to reduce or decrease the order, rank, or relevance of negative information. Having an adaptive inverse algorithm is desirable since search engine algorithms may change over time. This configuration may be setup such that negative information is hidden in random later pages in search results and relatively or automatically moving up positive information up to the first few pages of search results.

Similarly, altering or assisting by service provider 224 may be performed by adaptively using an order, rank, or relevance algorithm of search engine 202 to increase the order, rank, or relevance of positive information in an index or list stored in database 206. Having an adaptive algorithm is desirable since search engine algorithms change over time to improve results. This configuration may be setup such that positive information is in the early search results thereby relatively burying or reducing the placement of negative information in the higher pages of search results.

Altering or assisting by service provider 224 may be also be performed adaptively or intelligently using metatags to divert spider or robot component 204 from negative information to positive information thereby impacting or influencing the order, rank, or relevance in an index or list stored in database 206.

Referring again to FIG. 3a, apparatus 200 or search engine 202 receives a search request, command, or query from computer 228 by a user over wired or wireless communication link 226 (306). An inputted request or query may be one of or a combination of a keyword, text, document, sound, image, video, graphic, natural language, semantics, or the like received by search engine 202. Text inputs may be provided and searched in real-time as the user of computer 228 types. If apparatus 200 and/or search engine 202 is given a request or inquiry that will result in returning search results with sensitive information of another user or entity, apparatus 200 or search engine 202 may return a list having higher order, ranked, or relevant non-sensitive information (308) and other relevant information followed by random or a predetermined placement by rank of sensitive or negative information in later pages of the search results. The order, rank, or relevance may be generated on the fly by search engine 202 using indexed information or retrieved from database 206. Determining the sensitivity, order, rank, or relevance may be based on the examples given above. In order to dynamically conceal or bury sensitive or negative information, search engine 202 may randomly or dynamically change the placement of sensitive or negative information with each search request.

Moreover, if apparatus 200 or search engine 202 is given a request or inquiry that will result in returning search results with sensitive information of another user or entity, apparatus 200 or search engine 202 may return a list having higher order, ranked, or relevant positive information and other relevant information followed by random or a predetermined placement by rank of sensitive or negative information in later pages of the search results. The order, rank, or relevance may be generated on the fly by search engine 202 using indexed information or retrieved from database 206. Determining the sensitivity, order, rank, or relevance may be based on the examples given above. In order to dynamically conceal or bury sensitive or negative information, search engine 202 may randomly or dynamically change the placement of sensitive or negative information with each search request.

Using the examples above help to protect a user's reputation or privacy while providing robust search results. FIG. 3b is an example of search results provided by intelligent searching. Search results page 1 (310) comprises positive, non-sensitive, or less sensitive information 312₁-312₄ and other relevant information 314. Search results page X (316) comprises negative or sensitive information 318 and less relevant information 320. The search results page number X may be predetermined or set. Search results page number X may also be a random number generated with each new search request.

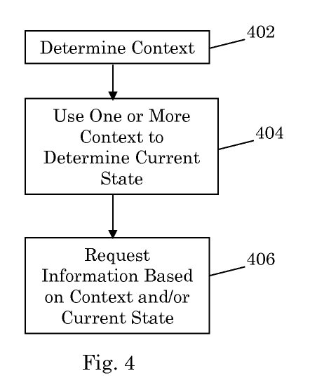

In accordance with another embodiment, FIG. 4 is a process for providing intelligent searching based on intelligent or smart context. Although the examples forthcoming may be for providing intelligent context for intelligent searching, the determined intelligent contexts and states may be used by any application, program, computer, and/or process. Example applications may be advertising systems, gaming, online gaming, a website, a cloud based service, an online application, an online service, or the like. Moreover, object device 100 may be configured with some, all, or other components not shown to provide the intelligent searching and context given below. In the examples forthcoming, context and present states may be determined by object device 100 in combination with another computer or device accessed over one or more network adapters 128. In the examples forthcoming, in order to protect privacy a user may opt-in or opt-out of any of the configurations.

Object device 100 determines context (402) using at least one or a combination of one or more processors 102, one or more interface controllers 104, memory 106 having software 108, storage device 110, GNSS device 114, IO devices 118, pressure sensors 123, touch detectors 124, and/or one or more sensors 126. The following contexts may be detected by object device 100: location, position, ambient heat, user heat, ambient temperature, ambient humidity, device moisture level, user body temperature, barometric pressure, user mood, user emotions, user heartbeat, user pulse, user physical state, user body position (e.g. sitting, standing, lying down), user motion, user brainwaves, user thoughts based on brainwaves, voice mood detection, user eye position, user facial position, user head position, user gestures, contents of user's breath, user habits, biometrics, biometric feedback, or the like.

One or more contexts may be used to determine current state (404) of the user or device by object device 100. States of a user or object device 100 may be determined by object device 100 based on a formula, equation, algorithm, or logic. For instance, if a user's body temperature and heartbeat are detected to be high by one or more sensors 126 the current state of the user may be distressed, angry, excited, or exercising. As another example, excitement detected by voice mood detection and user's breath having alcohol may be used to determine by object device 100 that the current state of the user is excited and at a bar.

Moreover, a user's detected alcohol level may be reported to law enforcement or adaptively change the operation object device 100. In addition if the user is detected as drunk, object device 100 may automatically deactivate a conveyance or vehicle in an abundance of caution by sending a command over one or more network adapters 128.

Besides the current state, a user's body temperature, heartbeat, movements, and/or mood may be monitored by object device 100 using one or more sensors 126 over a time period. Using the monitored vital signs and information, object device 100 may determine the user's condition to be irregular based on medical information stored in storage device 110 and/or by a medical service provider accessed over one or more network adapters 128. In addition to being identified as irregular, a specific medical condition may be detected or identified by object device 100 and/or a medical service provider accessed over one or more network adapters 128. The user may be informed by object device 100 to seek medical attention based on the identified medical condition.

As another example of intelligent medical context and state, object device 100 may track how often a user visits a bathroom facility. During a visit, object device 100 may also monitor a user's vital signs and/or if the user is vibrating or shaking, such as detected by an accelerometer of one or more sensors 126, during those visits to determine the user's state. A specific medical condition may be detected or identified by object device 100 and/or a medical service provider accessed over one or more network adapters 128 based on the determined user state. The user may be informed by object device 100 to seek medical attention based on the identified medical condition.

As another example, face or eye recognition may be used by object device 100 for determining user emotion, intoxication, health related conditions, or the like. For instance, if a user's pupils are dilated the user may be drunk or intoxicated. Face or eye recognition may be detected by a camera or infrared camera of one or more sensors 126 and determined by one or more processors 102.

As another example, a user's eye sight state or condition may be determined by object device 100 based on how close or far object device 100 is held to the user's eyes and the current size of displayed text. Distance to a user may be determined by a proximity sensor of one or more sensors 126. If a user constantly holds object device 100 close to read large text on one or more display devices 122, object device 100 may conclude that the user has questionable eye sight. This may be determined by detecting user facial position or user head position by a camera sensor of one or more sensors 126 over time.

As another example, one or more sensors 126 may be used by object device 100 to determine if a user is telling the truth or lying by detecting or determining heart rate, blood pressure, respiration rate, skin conductivity, and/or other biometric information. This intelligent context or state may be used to determine if a user is truthful when entering information on a form or application. For example, an official form may be a tax return. If it is determined by object device that there is a 60% chance the user lied on their tax return, this information may be shared with the Internal Revenue Service (IRS). The IRS may then take another look at the filing or begin an audit. In order to protect privacy, this configuration may only be used with prior tax cheats or offenders.

As another example, intelligent context and states may be determined by multi-touch inputs or swipe inputs. Touch detectors 124, pressure sensors 123, and/or one or more sensors 126 determine by the user inputs that a user is nervous, distressed, excited, or the like. For example, this may be determined if the user largely overshoots or undershoots selecting keys on a virtual keyboard, consecutively misses many soft keys, or the like displayed on one or more display devices 122. As another example, if there is a long delay between inputs on one or more display devices 122 and no data transmission is taking place, object device 100 may determine that the user is multitasking or preoccupied while typing.

Moreover, a pulse, heartbeat, skin conductivity, or other vital signs of a user may be detected based on the voltage, potential difference, or current applied between two fingers touching one or more display devices 122. The detection may be provided by touch detectors 124, pressure sensors 123, and/or one or more sensors 126. The pulse, heartbeat, or vital signs of user may be combined with other detected contexts to determine a current intelligent user state.

As another example, the intelligent context and states of a user or device may be determined by motion or orientation of object device 100 detected by one or sensors 126. For instance, if a user's hand shakes, as may be determined by an accelerometer in object device 100, the user may be nervous, distressed, or excited. In addition, if object device 100 constantly is shaking and moving it may be determined that it is in a conveyance, such as a car or train. Excessive shaking and motion may indicate that object device 100 is travelling over rough terrain. A medical condition may also be determined by object device 100 based on a user's hand shaking at a certain frequency or detected certain user motions over time, such as Parkinson's.

With respect to detected or determined medical conditions, the information may be shared by object device 100 to a server or online service that recommends doctors, specialists, or drugs to the user. In addition, ads or advertisements may be provided to object device 100 based on the detected or determined medical conditions in applications or during searches. In order to respect privacy, this may only be performed if opted-in or permission to share information is allowed by a user.

As another example, the intelligent context and states of a user or device may be determined by location or motion of object device 100 detected by GNSS device 114 and/or one or sensors 126. For instance, if a user is located in a park or field and moving around in a certain pattern and/or orientation with object device 100, it may be determined by object device 100 that the user is playing soccer, football, basketball, etc. or any other sport. If a user is located in a stadium or arena and jumping up and down with object device 100, object device 100 may determine that the user is at a concert and excited.

As another example, detected context may be combined with social network information by object device 100 to determine the state of a user or object device 100. The social network information of the user, the user's network of friends and/or the user's historical searches may determine past, current, and future states. This context and state determination may be done on the fly or using stored information on object device 100 and/or remote servers accessed over one or more network adapters 128. Context and social network information may also be used to determine disease origins and spreading of diseases. For instance, patient zero can be found quicker by health professionals by tracking user positions and social network information by object device 100 and/or a medical service provider accessed over one or more network adapters 128.

Other data points to determine intelligent context may be the user's demographics, time of day, and time of year. These contexts may be used with any of the contexts given to determine a user state by object device 100.

Once the state and context of object device 100 or a user of object device 100 is determined, a more intelligent search may be provided by requesting information based on the context and/or current state (406). In addition to searching, the determined intelligent states and context may be provided to a mobile application on object device 100, an ecommerce site, a server, an online application, an online service, or the like accessed over one or more network adapters 128 to provide intelligent services to a user and/or object device 100.

In addition, the context and states information may be used, if allowed by the user, to suggest products or develop custom sales pitch on a website. The context or state information may also be combined with other information, such as user demographics, when browsing a site to provide more relevant information. As another example, the user context or state may be used to automatically determine if a user likes or dislikes displayed information by object device 100, a website, a third party site, or the like.

Although features and elements are described above in particular combinations, each feature or element may be used alone without the other features and elements or in various combinations with or without other features and elements. The methods, processes, or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, a subscriber identity module (SIM) card, a memory stick, a secure digital (SD) memory card, magneto-optical media, and optical media such as CD-ROM disks, digital versatile disks (DVDs), and BluRay discs.

Suitable processors include, by way of example, a general purpose processor, a multicore processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement hardware functions for use in a computer or any host computer. The programmed hardware functions may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

Any of the displays, processors, memories, devices or any other component disclosed may be configured, produced, or engineered using nanotechology based nanoparticles or nanodevices.

What is claimed is:

1. A computer comprising:
a memory device and processor configured to provide a search engine, wherein the search engine is configured to receive a search request for sensitive personal information from a network;
a database with stored indexed information relevant to the search request for sensitive personal information, wherein the information includes non-sensitive personal information and sensitive personal information; and
the processor generating search results wherein the non-sensitive personal information is highly ranked in relation to the sensitive personal information.

2. The computer of claim 1, wherein the search engine is further configured to receive user context based on user motion detected by an accelerometer and the search results are based on the received user context.

3. A method performed by a computer comprising:
providing a search engine by a memory device and processor;
receiving by the search engine a search request for sensitive personal information;
storing in a database indexed information relevant to the search request for personal sensitive information, wherein the information includes non-sensitive personal information and sensitive personal information; and
generating by the processor search results wherein the non-sensitive personal information is highly ranked in relation to the sensitive personal information.

4. The method of claim 3, further comprising:
receiving user context based on user motion detected by an accelerometer; and
generating by the processor search results based on the received user context.
